(19) United States
(12) Patent Application Publication
(10) Pub. No.: US 2016/0019427 A1
(43) Pub. Date: Jan. 21, 2016

(54) VIDEO SURVEILLENCE SYSTEM FOR DETECTING FIREARMS

(71) Applicants: Michael Scott Martin, Lakewood, CO (US); Jeremy Ryan Soller, Golden, CO (US)

(72) Inventors: Michael Scott Martin, Lakewood, CO (US); Jeremy Ryan Soller, Golden, CO (US)

(21) Appl. No.: 14/204,781

(22) Filed: Mar. 11, 2014

(51) Int. Cl. G06K 9/00; G06K 9/62; H04N 7/18; G06T 7/00

(52) U.S. Cl. CPC G06K 9/00771; G06T 7/0042; G06K 9/6269; H04N 7/181; G06K 2209/09; G06T 2207/20081

(57) ABSTRACT

The present invention teaches that a computer system can be taught to analyze a stream of video surveillance imagery for individuals carrying firearms using a machine vision and machine learning system of the cascading classifier type, taught by special methods adapted to the firearm recognition area, in particular, exposure of the trained classifier to pre-categorized firearm images, and may poll a number of types of recognition methods before making a positive firearm recognition.

### CROSS-REFERENCE TO RELATED APPLICATIONS

This application claims the priority and benefit of co-pending U.S. Provisional Application No. 61/776,773 filed Mar. 11, 2013 in the name of the same inventors. The entirety of that application is incorporated herein by this reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### FIELD OF THE INVENTION

This invention relates generally to surveillance systems, and specifically to video surveillance systems utilizing video imagery and computer analysis.

### STATEMENT REGARDING FEDERALLY FUNDED RESEARCH

This invention was not made under contract with an agency of the US Government, nor by any agency of the US Government.

### BACKGROUND OF THE INVENTION

It has been found that video surveillance is an extremely effective method of deterring crime. In addition, it is a growing method of preventing terrorism.

However, video surveillance has certain issues, most notably the fact that it must of needs be monitored by a human operator.

The employers of the human operators appreciate the fact that the human being is the most expensive part of the video surveillance loop: the cost of the cameras and monitors are now negligible, the cost of wiring not terribly high, and so on. However, a human operator must be employed and paid a salary to carry out the monitoring.

Eager to minimize costs, the organizations which employ human operators have resorted to fairly obvious methods such as having one human operator monitor a bank of physical monitors, or having monitors “flip” from scene to scene provided by numerous different cameras. Since monitoring a video camera scene is fairly uninteresting work under most circumstances, operators tend to allow their attention to wander and even with utmost effort, the human attention span is known to be about 15 minutes, even less if the individual is uninterested. In some environments such as pool life guarding it is practical to rotate the guards every 12 minutes or so, but in the case of multiple video surveillance monitors this solution will drive up costs unacceptably.

The net result is that most video surveillance ends up being used in a reactive mode, that is reviewing the imagery and determining what already happened, when the huge potential of video imagery is in the areas already mentioned: deterrence and prevention.

One solution that is being developed in regard to recognition of human figures is having a computer analyze the imagery for human figures or faces, even going as far as to begin facial recognition technology in the surveillance context.

Use of a computer offers a number of advantages. The computer does not allow its attention to wander. A computer, once installed, is a relatively low cost item. A computer could conceivably monitor not just one or a few video streams but a large number.

In addition, a computer monitor of video surveillance streams could function as a first analysis of a number of streams which would be too large for effective human monitoring, and yet the computer's results could then be monitored by an operator, with the result that the operator would be able to skip viewing fairly mundane subjects and strictly view the imagery which the computer has already filtered, passed, or analyzed and found to be of interest. This not only increases the operator's efficiency due to seeing more of the relevant imagery and less of the irrelevant, it also increases the operator's efficiency due to motivational gains: the operator will be aware that what he or she sees has been previewed and found to be of interest.

Further in addition to that, human monitoring is not necessary if a computer system is capable of accurate discrimination that eliminates or reduces false positive alarms.

However, recognition of faces only carries surveillance technology forward to a certain degree. It would be more useful if a computer could analyze and image and find someone engaged in suspicious behavior even when the individual is not a known “face” of interest.

It would be preferable to provide a method for computer analysis of imagery streams seeking images which are of definite relevance even without facial recognition, such as individuals carrying firearms in suspicious environments such as schools.

### SUMMARY OF THE INVENTION

### General Summary

The present invention teaches that a computer system can be taught to analyze a stream of video surveillance imagery for individuals carrying firearms.

The present invention teaches that a machine vision system of the cascading classifier type used in medical settings, autonomous vehicles and so on may instead be used for firearm recognition.

The present invention further teaches that the trained classifier of the system of the system may be taught by special methods adapted to the firearm recognition area, in particular, exposure of the trained classifier to pre-categorized images so that it learns firearm recognition very effectively.

The present yet further teaches that the trained classifier of the system may use not just a single recognition method but several methods, including but not limited to contour recognition in the visible spectrum but also near and far infra-red spectra and in addition, the trained classifier may use advanced statistical methods of recognition, and may in fact poll a plurality of different analysis methods of the same video stream before making a definitive call of positive recognition.

### Summary in Reference to Claims

It is therefore another aspect, advantage, objective and embodiment of the invention, in addition to those discussed previously, to provide a surveillance method comprising the steps of:

providing a first video surveillance camera;

providing a scene analysis component which receives a video stream from the surveillance camera;

providing a movement determination module of the scene analysis component, the movement determination module operative to separate in the video stream foreground features which are dynamic from background features which are static;

providing a contour determination module of the scene analysis component, the contour determination module operative to determine the contours of foreground features in the video stream;

providing a trained person classifier module of the scene analysis component, the trained person classifier module trained to recognize a person in the foreground video stream;

providing a trained gun classifier module of the scene analysis component, the trained gun classifier trained to recognize firearms in the foreground video stream;

operating the video surveillance camera to provide the video stream to the scene analysis trained classifier, which monitors the video stream on a continuous real-time basis, the movement determination module providing to the contour determination module foreground features, the contour determination module providing to the trained person classifier and to the trained gun classifier modules contours of foreground objects; the trained person identifier providing identification of detected persons, the trained gun classifier providing identification of detected firearms associated with detected persons;

the scene analysis component providing positive recognition of a gunman/firearm in response to identification of detected firearms associated with detected persons;

the trained classifier, upon obtaining a positive recognition of a gunman/firearm, initiating a response.

It is therefore another aspect, advantage, objective and embodiment of the invention, in addition to those discussed previously, to provide a surveillance method wherein the trained gun classifier further comprises:

at least four trained gun type/view classifiers, a handgun right-side view trained classifier, a handgun left-side view trained classifier, a long-gun right-side view trained classifier, a long-gun left-side view trained classifier.

It is therefore another aspect, advantage, objective and embodiment of the invention, in addition to those discussed previously, to provide a surveillance method wherein the trained person classifier further establishes a person bounding box about any identified person, and further establishing left and right extension boxes as left and right regions of interest in relation to the person bounding box, the trained gun classifier using the left and right regions of interest as boundaries for its detection of firearms, the extension boxes in relation to person bounding box having one of the characteristics selected from the group consisting of: partially overlapping the person bounding box, partially overlapping one another, entirely overlapping the person bounding box, extending beyond the person bounding box and combinations thereof.

It is therefore another aspect, advantage, objective and embodiment of the invention, in addition to those discussed previously, to provide a surveillance method wherein a foot position is established at the centerline of the person bounding box and located ⅙ of the box height from the bottom of the box, the foot position updated continuously.

It is therefore another aspect, advantage, objective and embodiment of the invention, in addition to those discussed previously, to provide a surveillance method wherein at least one of the trained classifiers further comprises: a cascade classifier having a plurality of stages, each stage having unique vectors for filtering the video stream, each stage filtering the video stream in sequence.

It is therefore yet another aspect, advantage, objective and embodiment of the invention, in addition to those discussed previously, to provide a surveillance method further comprising the step of:

establishing a gun bounding box about the detected firearms.

It is therefore another aspect, advantage, objective and embodiment of the invention, to provide a surveillance method further comprising: a trained crowd classifier operative to identify crowds of persons.

It is therefore another aspect, advantage, objective and embodiment of the invention, in addition to those discussed previously, to provide a surveillance method further comprising:

training the trained classifiers of the system using a firearms database, the firearms database having therein numerous and differing images of firearms.

It is therefore another aspect, advantage, objective and embodiment of the invention, in addition to those discussed previously, to provide a surveillance method further comprising:

providing a secure training facility;

providing a simulated gunman who passes across a field of view of the first camera;

training the trained classifiers of the system using the video stream produced in the secure training facility.

It is therefore another aspect, advantage, objective and embodiment of the invention, in addition to those discussed previously, to provide a surveillance method further comprising: maintaining a set of vectors within the trained classifiers as a secret, so as to prevent gunmen from determining methods of evading detection.

It is therefore another aspect, advantage, objective and embodiment of the invention, in addition to those discussed previously, to provide a surveillance method further comprising:

an initial training stage in which persons/guns are manually indicated by bounding boxes in order to bootstrap the first iteration of the trained classifiers;

a secondary training stage in which persons/guns identified by the trained classifiers of the system are manually corrected.

It is therefore another aspect, advantage, objective and embodiment of the invention, in addition to those discussed previously, to provide a surveillance method further comprising:

providing a threat management component, the threat management component operative to receive the initiation of a response from the scene analysis component and begin procedures including at least one method selected from the group consisting of: tracking of the positive recognized firearm, initiation and maintenance of multichannel communications, maintenance of a response status indicator, execution of responsive measures and combinations thereof

It is therefore another aspect, advantage, objective and embodiment of the invention, in addition to those discussed previously, to provide a surveillance method further comprising:

providing at least a second video surveillance camera providing at least a second video stream to the scene analysis component, the first and second cameras forming a first network.

It is therefore another aspect, advantage, objective and embodiment of the invention, in addition to those discussed previously, to provide a surveillance method further comprising:

providing a second network comprising third and fourth video surveillance cameras providing at least a third and fourth video streams to the scene analysis component, the scene analysis component being located remotely, digitally programmed in a non-volatile memory of a computer processing unit;

tracking the gunman/firearm whenever the gunman/firearm is in the field of view of any camera in either the first or second network.

It is therefore another aspect, advantage, objective and embodiment of the invention, in addition to those discussed previously, to provide a surveillance method further comprising the steps of:

pre-calibrating a plurality of locations within the field of view of the first camera using geospatial coordinates;

performing a perspective transformation between locations within the camera video stream and the pre-calibrated geospatial coordinate positions within the camera field of view;

mapping the calculated foot position using geospatial coordinates;

providing a foot location history showing past foot positions;

mapping the foot location and foot location history onto a map using the geospatial coordinates;

displaying the map having the foot location.

It is therefore another aspect, advantage, objective and embodiment of the invention, in addition to those discussed previously, to provide a surveillance method, further comprising the steps of:

displaying the video stream having the gunman/firearm therein, superimposed with the person bounding box, the firearm bounding box, an identifier unique to the gunman, annotations of gunman geospatial coordinates location, time, rate of motion of the foot position.

It is therefore another aspect, advantage, objective and embodiment of the invention, in addition to those discussed previously, to provide a surveillance method, further comprising the steps of:

displaying an alert offering a choice selected from the group consisting of: respond, do not respond, tag as false positive, tag as foe (armed, threat, continue to track), tag as friend (armed, threat, continue to track), and combinations thereof.

It is therefore another aspect, advantage, objective and embodiment of the invention, in addition to those discussed previously, to provide a surveillance method wherein the step of displaying an alert further comprises: displaying an alert on a security monitor, displaying an alert on an SMS message, displaying an alert in an email, displaying an alert on a website, and combinations thereof.

It is therefore another aspect, advantage, objective and embodiment of the invention, in addition to those discussed previously, to provide a surveillance method further comprising:

displaying by means of a network the video stream having the gunman/firearm thereon.

It is therefore another aspect, advantage, objective and embodiment of the invention, in addition to those discussed previously, to provide a surveillance method further comprising:

updating the display until the gunman/firearm are no longer visible to any camera.

It is therefore yet another aspect, advantage, objective and embodiment of the invention, in addition to the several discussed previously, to provide a trained classifier of gunmen, the trained classifier produced by the following steps:

providing a secure training facility;

providing a simulated gunman who passes across a field of view of the first camera;

training a cascading classifier having multiple stages, using the video stream produced in the secure training facility, whereby a set of vectors for each stage is produced;

maintaining the set of vectors within the trained classifier as a secret.

### BRIEF DESCRIPTION OF THE DRAWINGS

FIG. 1 is a block diagram of a first embodiment of the device showing the overall system.

FIG. 2 is a block diagram of a second embodiment of the device, showing major components of the processing system and their relationships.

FIG. 3 is a simplified flow chart of the operation of the device.

FIG. 4 is a simplified block diagram of the threat and threat response management modules of the overall system.

FIG. 5 is another block diagram of the major modules of the system.

FIG. 6 is an exemplary classifier for the foreground of a scene.

FIG. 7 is an exemplary classifier showing foreground production and scene flow production made by the system.

FIG. 8 is a diagram showing the initial classifiers of the system, including gun classifiers, people detectors, etc.

FIG. 9 depicts a “left behind” classifier.

FIG. 10 teaches the “crowd classifier” needed not only due to the fact that crowds can be a threat or an object of interest but also because gunmen in crowded public places normally produce immediate flows of panicked people away from themselves.

FIG. 11 is a diagram depicting a single frame of an input scene, pre-classification.

FIG. 12 is a diagram depicting the isolation an d detection of a foreground object. Note that the foreground object may have been classified as a human being at this stage or not, since the flow of the process of the invention is flexible.

FIG. 13 is a diagram showing the “right” and “left” hand target regions in which the trained gun classifier will operate to search for gun-like objects.

FIG. 14 is a diagram showing the framing of a gunman and the additional framing of his firearm, after classification by the person classifier and the gun classifier. Certain basic information about the gunman is already available based on analysis of his location, motion, type of weapon and so on.

FIG. 15 is a diagram showing the complete image from the camera view, but with the framing from classification superimposed thereon.

FIG. 16 is a diagram showing the mapped layout of the gunman's area. This diagram is somewhat simplified but is accurate, for example, the coverage of the tripod mounted camera visible behind the gunman in FIGS. 11 and 15 is eliminated for prosecution clarity, however, the operative system in the possession of the inventors does in fact display the coverage triangles (fields of view) of all local cameras. Note that the map of the business is in fact accurate: comparison of FIGS. 15 and 16 reveals the accurate placement of the two doorways in the background, the gunman's location, etc.

FIG. 17 is a mapped view of the gunman's location, in this case the coverage maps of the cameras are shown, as well as the overall environs and the location of the gunman.

FIG. 18 is another mapped view, in this case the cameras' fields of view are omitted and instead an image based upon the image of FIG. 15 is shown instead.

FIG. 19 is a simplified view of a cascading classifier.

### INDEX TO REFERENCE NUMERALS

101 Video stream sources (cameras)
102 Connection from cameras to processing engine
103 Processing engine host server
104 Exemplary components of system
105 Recipients and respondents
106 Cloud service support
201 Trained classifier
202 Video input
203 Positive recognition of firearm
204 In situ testing system
205 Response/Threat management component
206 Cloud service support
310 Provision of components
320 Monitor image streams for firearms
330 Detection positive?
340 Activate threat management.
401 Active Gun Threat Input
402 Active Crowd Threat Input
403 Active Object Threat Input
404 Threat and Response Management Module
405 Informed Response
501 Source Image
502 Motion Foreground/Background
503 Optical Flow/Dense Flow
504 Foreground: objects discovered in foreground
505 Image Processing: Cascading and Composite Segmentation and Classification
506 People Classification Step/Module
507 Left Behind Object Classification Step/Module
508 Crowd Classification Step/Module
509 Gun Classification Step/Module
510 Research and Test Classifiers
511 General Detection Base Class: management of lists of detections and types
512 Derivation of classifiers from General Detection Base Class
513 Supervisor: Overall control of system
514 Calibration of system at multiple levels: classifiers calibration, foreground calibration, etc
601 Foreground input
602 Detection/classification of objects in foreground
603 Output of foreground objects
701 Foreground/movement detection, production of foreground and background images
702 Output: foreground
703 Optical flow: produces flow of entire image
704 Optical flow output
801 Foreground input
802 Optical flow input
803 Foreground input
804 Foreground objects
805 People classifier (detector)
806 Gun classifier (detector)
807 Potential gun detections output from gun classifier, input to people classifier
808 Active gun threat
901 Foreground input
902 Left behind classifier: looks for objects left behind in scenes
903 Active object threat output
1001 Foreground input
1002 Optical flow input
1003 Crowd classifier/detector
1004 Active crowd threat identified output
1101 Secure classifier training facility
1102 Training gunman
1103 Camera
1201 Foreground object isolated, optionally already classified
1301 Left side gun detection region
1302 Right side gun detection region
1303 Overlap region
1304 Training gunman isolated
1401 Isolated training gunman image
1402 Gunman frame
1403 Gunman information
1404 Training gun isolated
1405 Gun frame
1406 Gun information
1407 First foot location point, first color indicating first time span
1408 Second foot location point, second color indicating second time span
1501 Combined image output: foreground/gunman with information, superimposed onto scene imagery
1502 Scene/background/secure classifier training facility
1601 Secure classifier training facility
1602 Camera
1603 Arc indicating field of view
1604 Gunman
1605 Area too close to camera to allow view of floor
1606 Area in which human feet will be visible on floor/locatable
1607 First foot location point, color indicating age of location fix
1701 Building/structure/area display, output to user
1702 Exemplary building feature (rear parking lot)
1703 Camera location spot (geospatial coordinates)
1704 Field of view of camera
1705 Area too close to camera to allow view of floor
1801 Building/structure/area display, output to user
1802 Exemplary building feature (rear parking lot)
1803 Gunman location spot (geospatial coordinates)
1804 Image of gunman, with information: date, time, location, speed, weapon class, etc
1901 First stage simple filter
1902 Second stage simple filter
1903 Third stage simple filter
1904 Nth stage simple filter

### DETAILED DESCRIPTION

The present invention makes extensive use of trained cascade classifiers searching real-time imagery for Haar-like features.

The task of visually identifying objects in a video stream is extremely time consuming. One method of allowing fast analysis of such imagery is the use of cascading classifiers. A classifier is simply an algorithm or set of simple vectors which are used as a filter over every region of interest in a stream of imagery. If the region being tested (being filtered) meets the simple criteria, then it passes the filter. Since the goal is speed, that is, a real-time image recognition, the filter must be extremely simple. After passing the first, fast, simple filter, the same region goes to a second stage filter for analysis using a second, different, set of vectors/algorithm. If it passes the second stage filter, it goes to a third stage and so on. In the present invention, twenty stages or more are perfectly acceptable, as each stage is an extremely low computational burden.

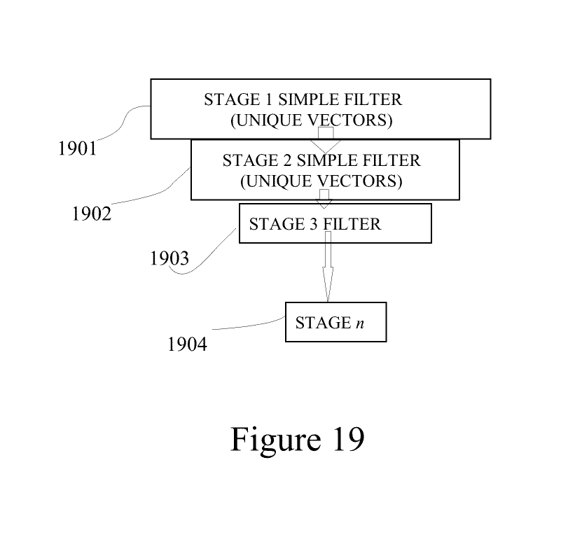

FIG. 19 is a simplified view of a cascading classifier. First stage simple filter 1901 passes only some of what it analyzes on to the second stage simple filter 1902. Third stage simple filter 1903 only receives those areas of the video stream which include elements passed by both stages one and two. Thus Nth stage simple filter 1904 receives only those items which have passed every filter above it in the sequence.

The advantage of this in terms of processing is extremely obvious: only a simple filter, stage one, needs to be run on every pixel or region of pixels of the video stream. Stage two only analyzes, and only uses processor time, for those items which passed stage one. By the time later stages are used, the vast majority of input has been filtered, discarded, and is no longer consuming clock cycles, while the system is easily able to do in-depth analysis of areas of interest.

Extremely simple filters in turn bring up their own set of problems, in particular, false positives and false negatives. In the present context, safety, false negatives are unacceptable, so the simple filter of any given stage is biased to provide very few false negatives and many false positives. A filter which has a false positive rate of 50% is in fact acceptable, if it has a false negative rate of approximately 0%.

The reason the large number of false positives from any single stage is acceptable is of course that numerous stages will follow the first stage, each stage with its own set of vectors, and the stages will tend to quickly filter out the false positives of the stage before them, due to having different vector—different characteristics that are used. A first simple filter that properly filters out 90% of what is input, with a 50% false positive rate (that is, falsely allowing 5/90 of the negative images to pass), will pass on about 15% of what it sees to the next stage. That next stage in turn, if it has similar mathematical characteristics, will pass on only 5/90 of the 5% false positives it received from the first stage, that is, about 0.277 percent of the total input will now be false positives after only two stages. After twenty stages, this false positive rate will be extremely close to zero.

The reason that false negatives (that is, filtering out objects which should have been recognized) is not acceptable is that if a given stage incorrectly filters out a digital object in the imagery, that object is removed from the cascading classifier and cannot be added back in by any later stage. If a twenty stage system has a false negative rate of only 2% per stage, by the final stage fully ⅓ of the positive inputs will have been filtered out and missed.

Thus cascading classifiers with individually extremely simple detection algorithms are an extremely efficient way to search large quantities of imagery for objects or persons of interest.

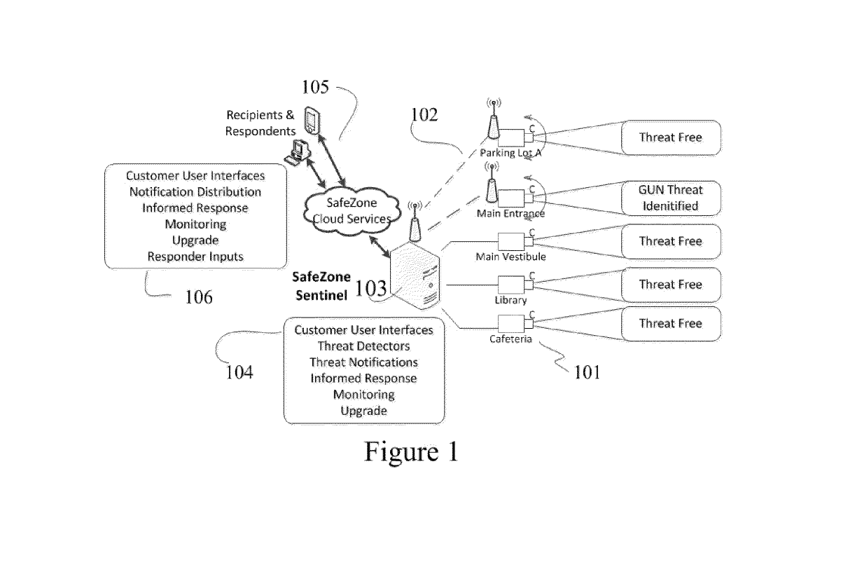

FIG. 1 is a block diagram of a first embodiment of the device showing the overall system. 101 marks video stream sources such as video cameras, IR spectrum or visible spectrum, and other input devices which produce video streams or even regular still images. As the cost of such devices has lowered and their use has boomed, the number and availability of such devices has made them attractive for use in this application.

102, the connection from the cameras to the processing engine of the system may be wireless or wired in a great number of ways: video cable of various types, optical cable, wireless protocols such as many cameras already offer, Bluetooth® wireless and many more now know or later discovered are so covered.

103, the processing engine host is simply a computer or computation device acting as the host for those components of the system which reside in situ. Note that while this depicted to be a small computer located on site or near enough for cable connections (in this case, in a school building) the server/host may in fact be remote in alternative embodiments of this invention.

104, exemplary components of system, are depicted to be threat detection, threat management, and threat tracking, and so on. However, many components may be included.

105 “recipients and respondents” indicates that the system does not exist in a vacuum, rather it becomes a communications node in the event of a positive weapon detection: notifying human operators, law enforcement, school administration, setting off alarm systems, activating passive defenses such as barriers and gate and door locks and so on and so forth.

106, the cloud service support, provides the preferred method of supporting the complexities of this system. For a system this complex, these services are vital in order to maintain the system in proper running condition over time, as well as for updates, repairs and so on.

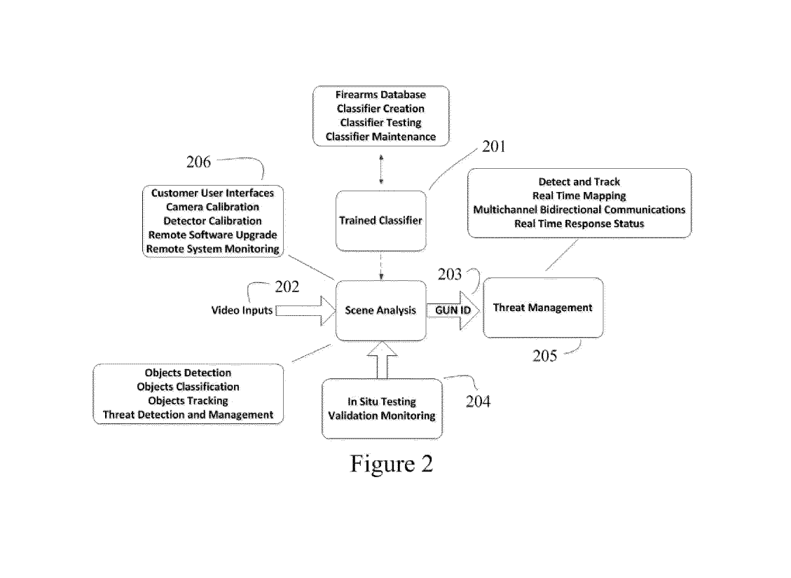

FIG. 2 is a block diagram of a second embodiment of the device, showing major components of the processing system and their relationships.

201 is the heart of the system, a trained classifier system of the cascading classifier type. While such systems have been used in facial recognition, vehicle recognition and so on, those systems have been trained/conditioned differently than is appropriate for the current application of firearms detection.

In training of a firearms recognition classifier, there are several methods which may be used. For example positive training may involve taking pictures of firearms of a wide variety of types against a high contrast background, loading such pictures into a training system database, eliminating the background, cropping and so on to produce a definitive image for the trained classifier to learn.

Positive and Negative training on the other hand makes use of the ability of the software to learn. Positive and negative database entries superimposed with changes in image values such as light, angle, rotation, and so on, then allowing the application to use the resulting classifiers. This process may be repeated with ever greater granularity to produce larger number of classifiers and improve performance.

202, video input, shows the video stream entering the scene analysis component/module, which then uses the trained classifier to detect firearms in imagery.

203 represents a “positive” return, meaning the recognition of a firearm in the video stream, which immediately results in the activation of the threat management module with actions such as were discussed previously in regard to reference number 105.

204 is an in situ testing system, necessary to ensure that the very complicated statistical and contour recognition methods employed are functioning properly. In addition, this system notifies the cloud services support of system parameters.

205, the response or threat management component of the system is used to provide tracking of the detected firearm, now classed as a threat, including tracking from camera to camera in some embodiments, to maintain a response status, and importantly to serve as a communication node, sending relevant data to responders, occupants of the safe zone, those nearby and so on.

206, cloud service support, provides a convenient method of supporting the complex software of the system. By means of cloud support, such as IP protocol based support, remote service, training, validation, testing, monitoring and data mining may be implemented. For a system this complex, these services are almost required.

Broken out in list format, this diagram shows vital parts of the system as follows:

The system is dependent on a Trained Classifier for threat detection

Classifier training requires a set of reference images, in this case from a Firearms Database.

The Classifier is Created and conditioned with the training data.

The Classifier is then tested for effectiveness.

The Classifier is Maintained by making changes to the training set, remaking, and re-testing.

Video inputs are inputs into the Scene Analyzer

The Scene Analyzer detects objects present in the scene (real time)

The Scene Analyzer Classifies objects detected.

When the Scene Analyzer detects a threat, such as a gun, the Threat Management processes are activated.

The Scene Analyzer tracks detected objects.

When a Gun is detected, the Scene Analyzer notifies and activated Threat Management.

The system includes software and notifications to perform automatic Validation of operating Systems.

Validation status is automatically communicated to Remote Systems Monitoring.

Threat Management includes:

Track

Initiate and manage Multichannel communications

Maintain response status

Execute response actions as appropriate

Cloud Services include: more than monitoring and upgrade, it also includes notification services as discussed below, provision of a website or other visual alert as discussed below, informed response in general as discussed further below, cross-network tracking, a thin client user interface providing a secured customer portal, and a wide range of other components of the system which operate on a server/Cloud rather than in a single sentinel unit. This allows wide-range tracking and mobile support. And it does include:

Remote Software upgrade

Remote monitoring

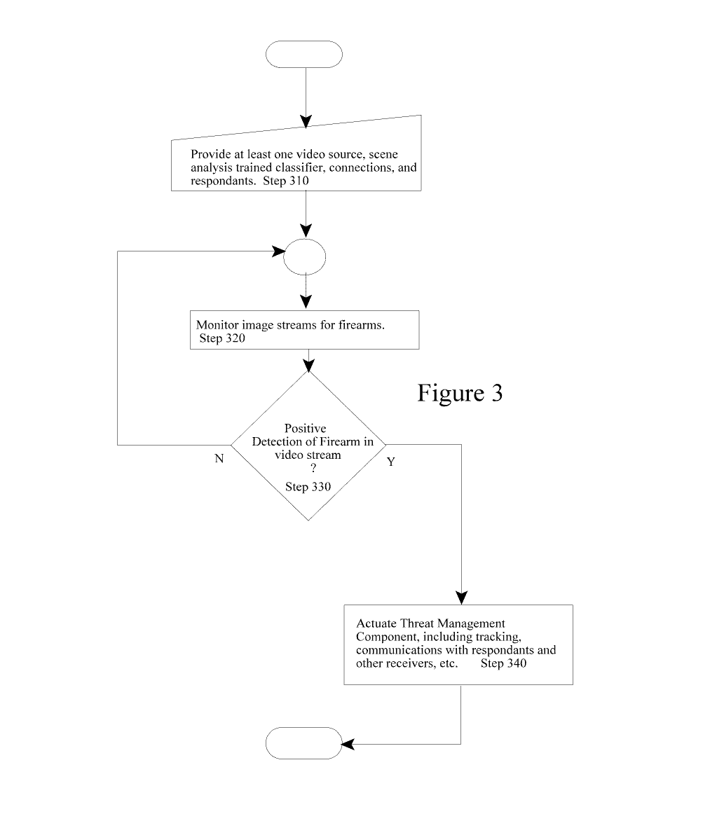

FIG. 3 is a simplified flow chart of the operation of the system of the invention, showing major steps but by no means all the steps of the invention as discussed previously.

Step 310 is the provision of components, subsumed within this step is the unique step of training the classifier in appropriate ways to recognize firearms. Thus, without providing a fully trained cascading classifier this entire process is impossible from the start, a fact which renders this method unique compared to all previous methods known to the inventors at this time.

Step 320 is the continuous monitoring of the image streams for firearms by the scene analyzer, using the trained classifier component.

Step 330 represents the scenario for which the system is designed, a “positive” result, meaning the detection of a weapon in the field of view of one of the input stream sources (cameras).

Step 340 is the response, which is to activate the threat management operations of the device. As discussed previously these involve notifying a higher level (human) operator, notifying responders, potential victims such as school occupants or passersby and even beginning passive, or even active, defensive measures such as the system has been pre-authorized to use, if any. The major modules of this step are shown in the next diagram.

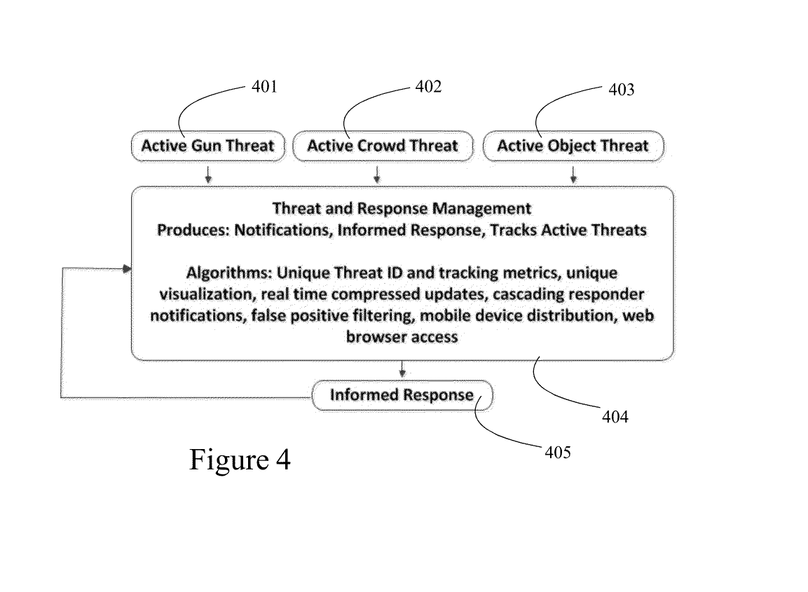

FIG. 4 is a simplified block diagram of the major modules of the threat response system. Active Gun Threat Input 401, Active Crowd Threat Input 402 and Active Object Threat Input 403 all are provided to the Threat and Response Management Module 404.

Informed Response 405 is then possible because the responders will have a good deal of information available to them, provided by the system.

In particular, as discussed below, the first responder, also called a user, will have the real time video stream containing the identified threat(s), and superimposed thereon may be a bounding box for a gunman with associated firearm bounding box, a unique identifier (such as “Gunman 7603”) assigned by the system, location in geospatial coordinates, time of contact, speed of the threat motion, weapon identifier (“Long Gun”), and more. There will be a foot position indicator and more importantly, a foot position history consisting of multi-colored or otherwise indicated past foot positions and the time span in which they were detected, so that the first responder will have the option of analyzing the past moves of the gunman and using them to make assumptions about future moves.

The user will also have informed response 405 in terms of notification, which may occur by means of an alert screen on a dedicated security system, or by email, SMS/text message, a recorded or live telephone call, or other means.

The user will then have the ability to flag the located threat in various ways. Table One illustrates some possible flags which can be set.

TABLE ONE

| STATUS | FLAG |
|---|---|
| False positive | 1 |
| Friend (armed, threat, track) | 2 |
| Foe (armed, threat, track) | 3 |
| Peaceful crowd (track) | 4 |
| Crowd threat (threat, track) | 5 |
| Threat item (threat, track) | 6 |
| Miscellaneous threat (threat, track) | 7 |

It will be noted that most items are tracked. For example, if a law enforcement official with a gun (a “Second responder” as used herein, the first responder being the user who receives the initial alert and makes the initial flagging) is approaching the scene of a detection, the system will trigger a new threat ID. After identification it might seem that tracking the law enforcement personnel/second responders is pointless, however, the system will of course need to have a means of avoiding constantly re-alerting on the same friendly person, so tracking that person from camera to camera and network to network is needed.

There is also a major advantage to tracking friendlies with the system. The responder/user may be seated at a distant location such as a security office, police dispatch center, incident van or the like and thus free to simply monitor the system's tracking of the location of the friendly and the gunman. The user can then vector the official in verbally, by means of fairly obvious instructions such as, “I see him moving toward the south end of the building and looking your way, don't go through that door yet.” This is not possible if the system ceases to track the friendly second responder, unless the user/first responder is manually tracking the friendly themselves, thus increasing their own workload in a stress situation.

Note that the friendly may themselves receive this information, even the video stream with annotations, boxes, etc, in the process of response. In one embodiment the invention provides a website or other network available display which is constantly updated with the annotated video imagery as the system tracks the threat from camera to camera. Thus if the friendly has a mobile device such as a telephone, pad, tab, etc or the like, they can in fact vector themselves in visually, while constantly spying on the threat. However, this requires the friendly who is moving toward the threat to take their eyes off the situation and use a mobile device, and this seems like a less preferred embodiment.

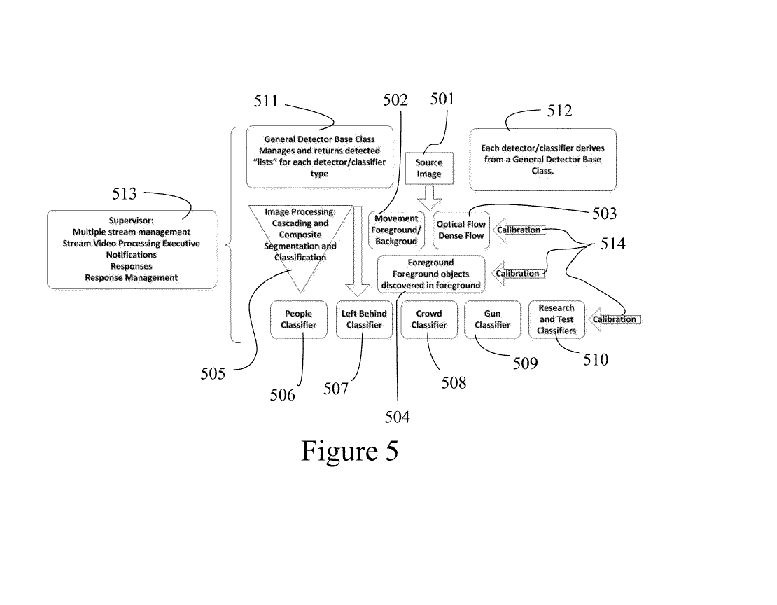

FIG. 5 is another block diagram of the major modules of the system. Source Image 501 is the video stream. The first analysis which occurs is Motion Foreground/Background determination 502. Objects which are moving or have been previously tagged are foreground, objects sitting still are background, though this rule is only the most general statement. Thus the first step is motion determination and the second is fore/back ground determination, followed by contour analysis.

Optical Flow/Dense Flow on the other hand is a complete set of video data as the stream progresses. It goes without saying that the system may or may not record constantly, all activity of any sort within the field of view of the cameras, however, the amount of data which might end up being stored could be quite staggering. Thus in a preferred embodiment, the dense flow is not stored permanently except during times when an alert/detection occurs. Foreground, meaning objects discovered in the foreground 504 and the dense flow are both subject to Image Processing: Cascading and Composite Segmentation and Classification, though the dense flow may only be subject partially, at some times, or not at all, depending on optional embodiments of the invention.

Cascading has been discussed previously, it is by means of cascading analysis and filtration that real time processing ability is achieved. Composite segmentation refers to the ability to break the image down into various parts: foreground, classified persons, extension boxes (regions of interest), classified handguns, crowds, and so on. Classification refers to the ability of the system to take segmented parts of the image and classify them as people or handguns.

Module 506 is the People Classification Step/Module in which foreground objects are classified as people. At a first step, a first stage might pass objects which are generally three to five times as tall as they are wide as being people. A second stage of the identifier might hunt for a generally elliptical top end of the potentially humanoid object and if it is found, pass it to a third stage which might have vectors/algorithms trained to hunt for approximately four major limbs and so on and so forth. The objective, of course, is to have extremely simplistic analysis at any one level for fast operation in the computer processor unit which has the system programmed thereon in non-volatile memory, and yet to cumulate these simple, fast analyses until an extremely sophisticated and uncannily accurate determination of whether a person and gun have been detected. Testing in the real world has confirmed that this degree of sophistication and freedom from false positive results has been achieved.

Step/module 507, the Left Behind Object Classification Step/Module, is obviously necessary in order to update the scenes for background, however, it is also another threat alert: a person can leave behind such things as explosive devices or other devices of extreme interest.

Module/step 508, the Crowd Classification Step/Module is necessary for several reasons. First of all, a crowd can be a threat. In addition, a sufficient number of individuals in extremely close proximity might make handgun identification difficult (for example, by masking other individual's guns with their bodies). In addition to that, the sudden appearance of a gunman can produce a crowd of people moving away extremely quickly, thus taking processing time away from tracking the gunman. Thus for numerous reasons it is desirable to provide a crowd classifier as well.

Box 509, Gun Classification Step/Module, is of course the central item of interest. This cascading classifier may use any of various types of analysis (Haar-like identifiers for example) to identify guns. Guns which are in the foreground (moving) become of extreme interest and trigger an alert of the system.

It is worth noting the existence of various other classifiers and filters which the system uses, including foot classifiers, height filters (filtering out camera results which seem to indicate gunmen of heights exceeding or subceeding human limits), hand classifiers and so on and so forth. For the sake of avoiding prolixity not every individual module of the system can be discussed herein.

Step 510, Research and Test Classifiers, is obviously necessary in order to create and improve the system.

Step 511 merely indicates that the various types of detections must be managed: is an identified gunman the only gunman or are the multiple gunmen who must be separately identified and tracked, and so on. Thus there are higher level data structures in the classifier lists. General Detection Base Class: management of lists of detections and types, indicates this. Derivation of classifiers from General Detection Base Class is thus necessary (step 512).

Overall control of the system is also mandatory, of course. Module 513, the supervisory module, handles multiple data streams, multiple networks for different customers of the system or different installations of the system, alerts/notifications, sysop duties, software maintenance, system maintenance, system security access, responses, and so on and so forth.

Finally, calibration of system at multiple levels: classifiers calibration, foreground calibration, etc, is necessary. For example, each camera in the system should have a geospatial coordinates location of its field of view, as explained later. Thus a simple calibration is to locate four spots within the camera field of view and map their location extremely accurately. Another example of calibration would be to teach the system how to assess foreground versus background discrimination.

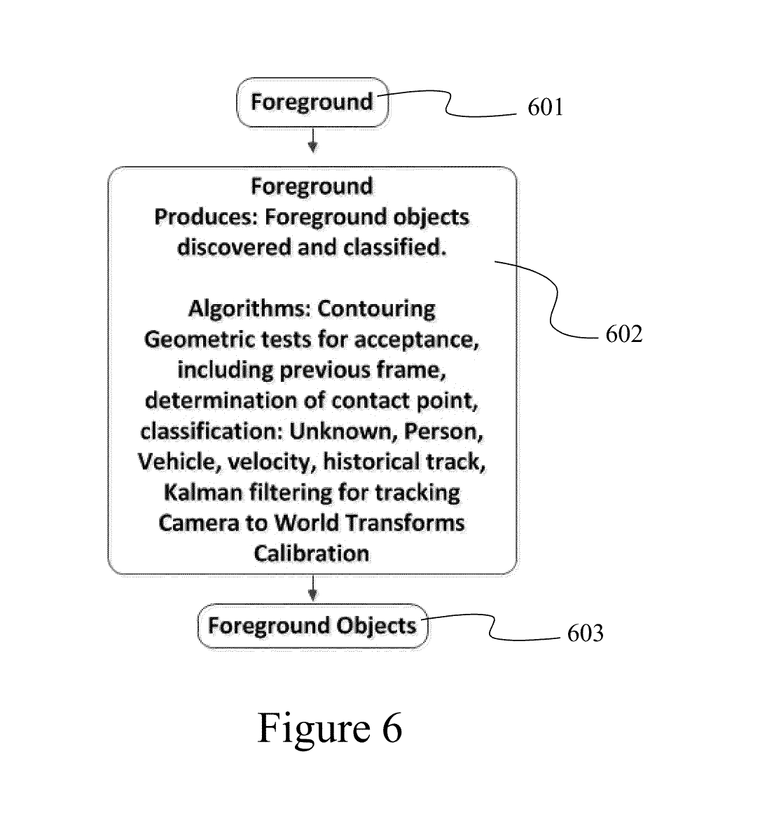

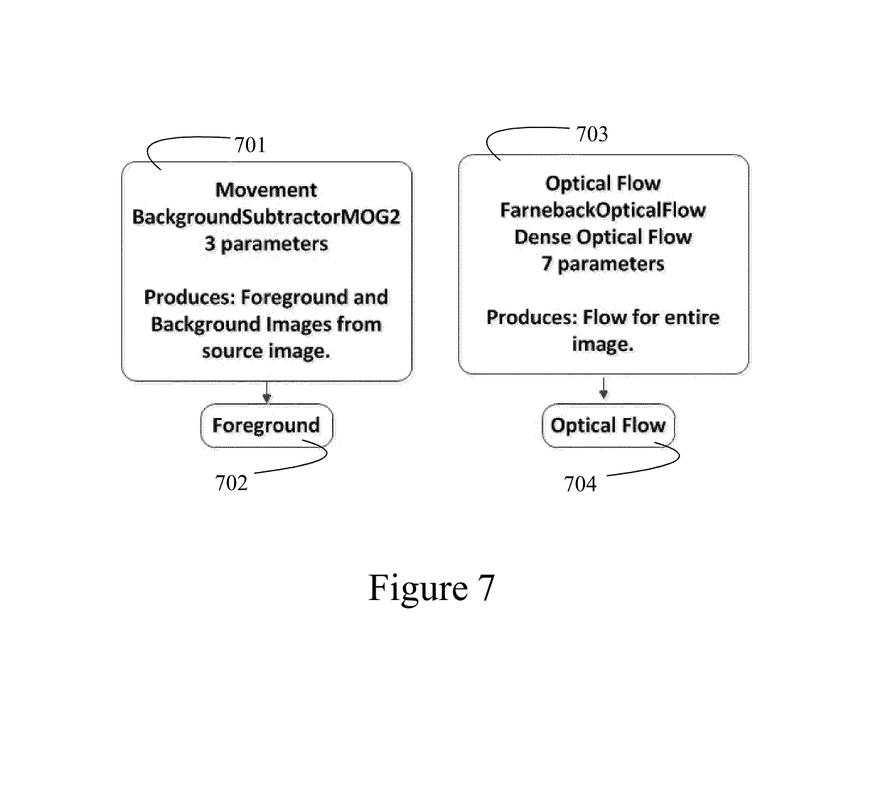

FIG. 6 is an exemplary classifier for the foreground of a scene. Foreground input 601 leads to the detection and classification of objects in the foreground, as shown. Thus a good deal of analysis is necessary at this stage. Without the successful determination of what is foreground, no further processes can be reliable. For example, a system which failed to detect as foreground and classify as persons 25% of persons passing by would be at least 25% probable to overlook a gunman through failure to even analyze him. Thus step 602 is crucial to further operations based upon the output it provides (602) of foreground objects. This may be seen further in reference to FIG. 7.

FIG. 7 is an exemplary classifier showing foreground production and scene flow production made by the system. Foreground/movement detection, production of foreground and background images (module 701) produces the foreground output 702. On the other hand the flow of the entire image, a necessary component of the system, is created by module 703 and that output is 704.

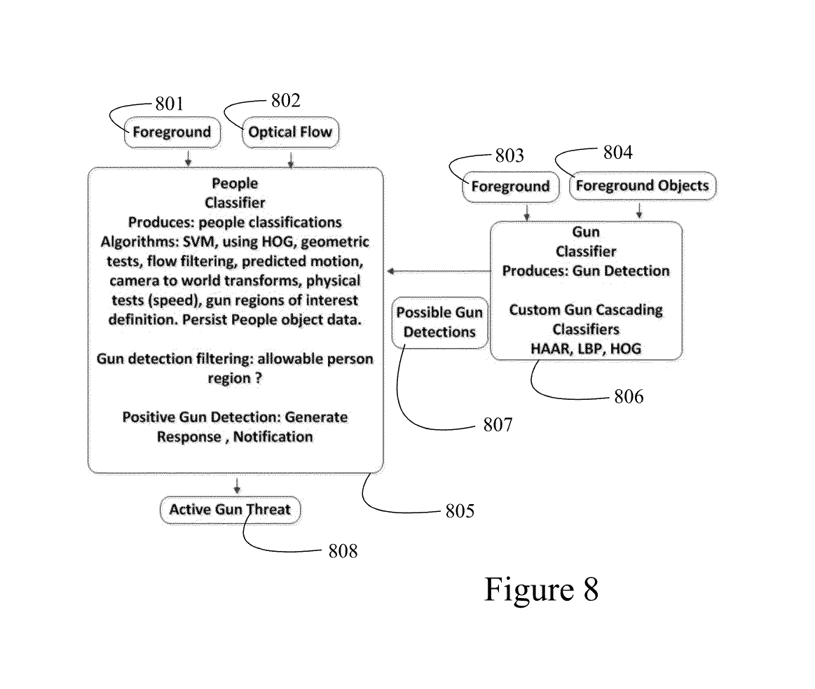

FIG. 8 is a diagram showing the initial classifiers of the system, including gun classifiers, people detectors, etc. Foreground input 801 and optical flow input 802 go to people classifier 805. Foreground input 802 and foreground objects 804 meanwhile go to gun classifier 806.

805, the people classifier, is more or less a person detector, while 806, the gun classifier, is more or less a gun detector. Various filters might be used (Haar, LBP, HOG, etc) in the cascading classifier system but the net result is that if anything successfully passes through the entire depth of the cascade (as noted, the system as developed has 20 levels of filtration in the cascade and more or fewer are possible in alternative embodiments), then becomes a potential gun detection 807, which is output from the gun classifier and input to people classifier 805. If the people classifier 805 identifies the gun as being associated with a person, then an “Active gun threat” 808 has been located and an alert to the first responder/user is made.

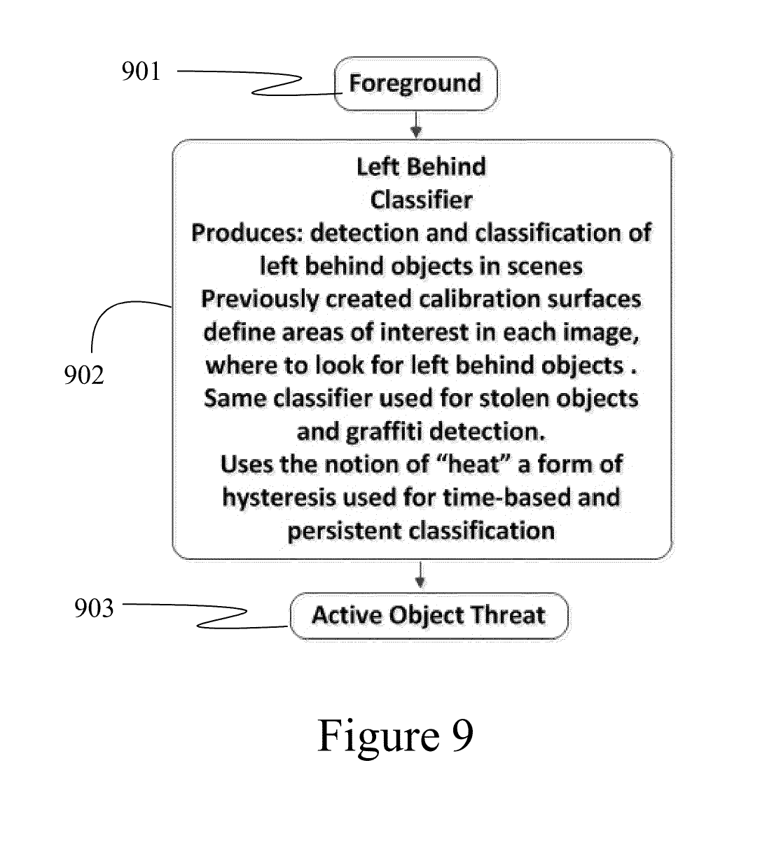

FIG. 9 depicts a “left behind” classifier. Foreground input 901 is used. However, previously carried out calibration of surfaces of interest is used to make a determination that something has changed in the background. This is useful for a number of reasons, for example, to prevent a person who is unarmed from arming themselves with a piece of the background (a gun from a rack, etc) without being detected, and for explosive devices, etc. Thus the “Left behind classifier” 902 looks for objects left behind in scenes and if necessary triggers an active object threat output 903.

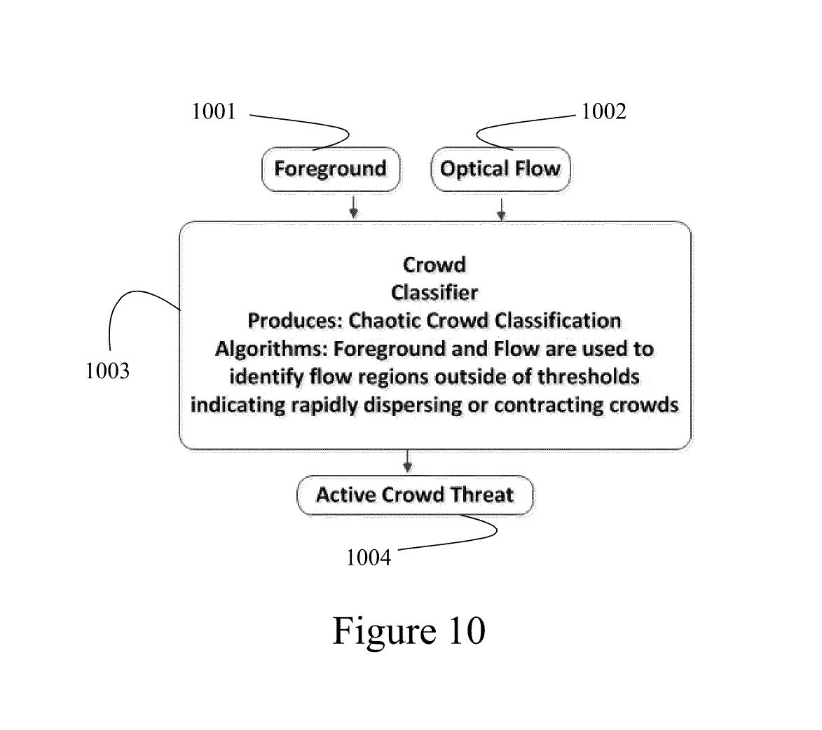

FIG. 10 teaches the “crowd classifier” 1003 needed both because crowds can be a threat and also because gunmen in crowded public places normally produce immediate flows of panicked people away from themselves. Foreground input 1001 is useful when flow outside of normal thresholds (mass motions of groups) would make normal analysis impossible due to the domination of the flow/foreground in the overall optical flow output 1002. Under such circumstances, an active crowd threat identified output 1004 is made. Note that the crowd “threat” in this case might well be similar to a friendly second responder “threat”: not actually hostile but something which must be tracked for operation of the system to continue even if there is no hostile intent.

### EXAMPLES OF ACTUAL TESTING AND USE

### Example One

Following filing of the provisional application referenced above, a real-world technical test has been initiated by approaching a testing law enforcement organization and requesting their cooperation, after which a test system according to the present invention has been installed. The location is in a town having large quantities of foot traffic therethrough, carrying sporting equipment. The test facility is a multi-level parking structure including at its southwest corner a small three-level shopping and restaurant arcade with a number of commercial establishments therein. The initial configuration included 10 surveillance cameras tied in to the classification and alert system but is growing to include more. The testing organization reports that they desire to move from a system testing configuration (in particular, testing of the cascading classifiers) to a full coverage configuration. They report that after tuning the system does not return an excessive number of false positives.

### Example Two

A classifier training system and facility is established in the metropolitan Denver area, this training system is partially visible in the following black and white diagrams. “Trained” cascading classifiers obviously require training before they can function, and happily real-world footage of gunmen walking through public places is fairly difficult to acquire. The secure and confidential training facility thus provides a confidential location at which images of gunmen can be produced and provided to the system of the invention so that the trained classifiers may be exposed to positive hits and refine their recognition algorithms.

In use, the exemplary gunmen pass through the fields of view of the network of cameras installed in the system, thus creating test video streams for the system. The video imagery is then fed through a classifier training module which uses the imagery to derive and/or refine the vectors/algorithms within the various stages of the cascading classifiers. This process is computationally intensive, for example, a week might be spent in processing the video imagery and deriving a better, more intelligent trained classifier. Multiple iterations of this make the process painstaking and prolonged.

One interesting problem which arises is that the training program starts tabula rasa, without any vectors at all. Thus bootstrapping the system in order to obtain the first iteration of the vectors, the first round of training of the system, may require manual boundary boxing of the firearms shown to the system. This labor intensive process then allows the system to derive a first iteration, after which, the system can be trained as discussed previously, without manual boxing.

This in turn means that the gun classification vectors derived are proprietary and must be kept secret so as to avoid evasion by gunmen who could reproduce a system and use it to determine when it does not detect a person or a gun.

Note that the boundary boxing, annotations and other data presented in the Figures below are in fact NOT manually created: the system has created these and the applicant is fully in possession of the invention.

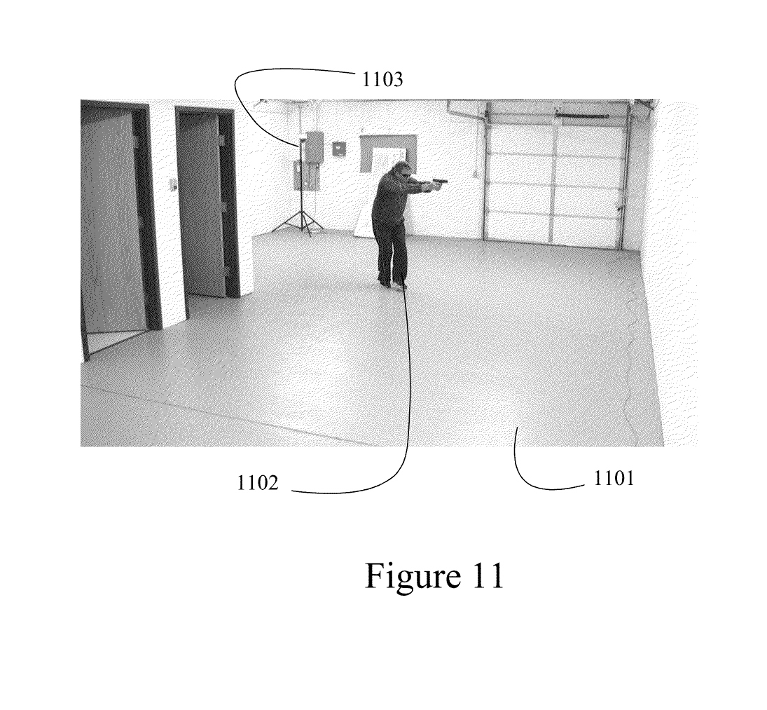

FIG. 11 is a diagram depicting a single frame of an input video stream, pre-classification. Secure classifier training facility 1101 may be seen, within which training gunman 1102, armed with a typical firearm (a Glock brand semi-automatic pistol in this case), is moving about. In the background camera 1103 may be seen: the cameras in the facility have massively overlapping fields of view to increase processing accuracy in the training phase.

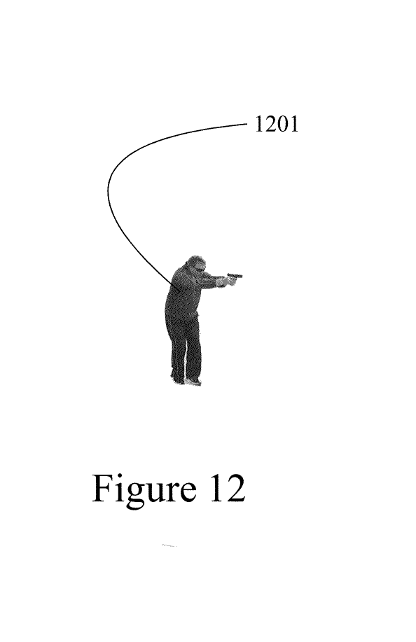

FIG. 12 is a diagram depicting the isolation and detection of a foreground object. Note that the foreground object may have been classified as a human being at this stage or not, since the flow of the process of the invention is flexible. Thus while normally identification of foreground, and contour mapping, is carried out prior to human classification, in alternative embodiments the order is different or the foreground determination may be skipped and yet fall within the scope of this invention as claimed.

Foreground object 1201 is isolated, and optionally already classified

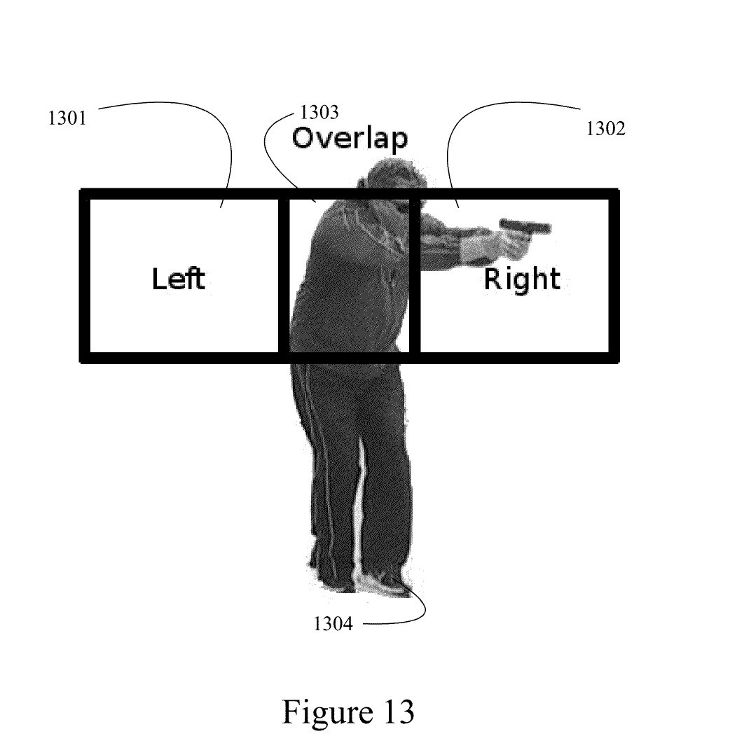

FIG. 13 is a diagram showing the “right” and “left” hand target regions in which the trained gun classifier will operate to search for gun-like objects.

Left side gun detection region 1301 is one area analyzed for the presence of a firearm. Right side gun detection region 1302 is another such area. In this case, most of the image need not be examined because a gun identification which is nowhere near a human being is of no interest, and thus processing in real time is enabled in this way too.

1303 represents the overlap region, where the regions of interest, the two extension boxes 1301 and 1302, overlap. Since long guns tend to be carried with one end projecting beyond a person bounding box and the other end at the shoulder, this is necessary.

The training gunman 1304 is isolated in this image, however, in alternative embodiments processing capacity may be sacrificed in order to skip the isolation step.

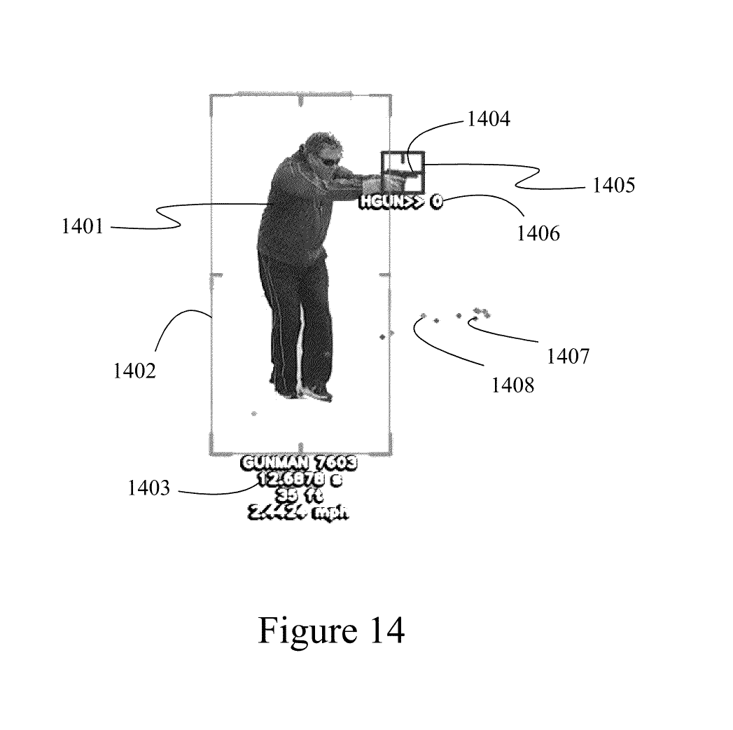

FIG. 14 is a diagram showing the framing of a gunman and the additional framing of his firearm, after classification by the person classifier and the gun classifier. Certain basic information about the gunman is already available based on analysis of his location, motion, type of weapon and so on.

At this point the power of the system is becoming apparent. The present invention is not about automating a manual process (identification of gunmen on screens). Rather, the invention teaches that a massive amount of video input can be successfully filtered, analyzed, and used to return a unified, coherent display which instantly provides to a human user information the human would not be able to assemble in one single display at all.

Thus isolated training gunman image 1401 is picked out for easy human recognition by means of gunman frame/bounding box 1402 (which is also a component of the classification process, of course). Gunman information/annotations are also provided 1403, including as can be seen, an identifier, the distance and direction of the gunman from the camera (which can be augmented, as explained later, with geospatial coordinates information and thus even address and room information), the speed at which the gunman is moving (a brisk walk of 2.4 miles per hour), and more.

But in addition to that, the training gun is also isolated, 1404. A bounding box/gun frame 405 is provided (in the actual photographs/video of the system, the bounding boxes and annotations are in differing colors for easy human recognition, but in the black and white diagrams this is not shown, and in alternative embodiments colors may be avoided). Gun information 1406 may be provided (handgun), number of weapons, and in alternative embodiments even the type and visible status of the weapon might be provided (locked open, raised, aimed, Kalashnikov, etc).

One extremely important aspect and advantage of the invention is indicated by reference number 1407, the first historical foot location point, whose first color/grey scale indicates it occurred within a first time span, for example, “more than 10 seconds before, less than 1 minute old” or the like.

Number 1408, the second foot location point, second color indicating second time span (perhaps, “less than 10 seconds old”) may indicate instantly and visually to the first responder the direction of the gunman's motion. As discussed elsewhere, the instantaneous foot location may be found by various numerical methods, however, testing has determined that the speedy process of dividing the person bounding box height to ⅙ yields an accurate answer without need to advert to the foot classifier (which serves other purposes).

As helpful as this image is, it is not in fact anywhere close to the full presentation the system generates.

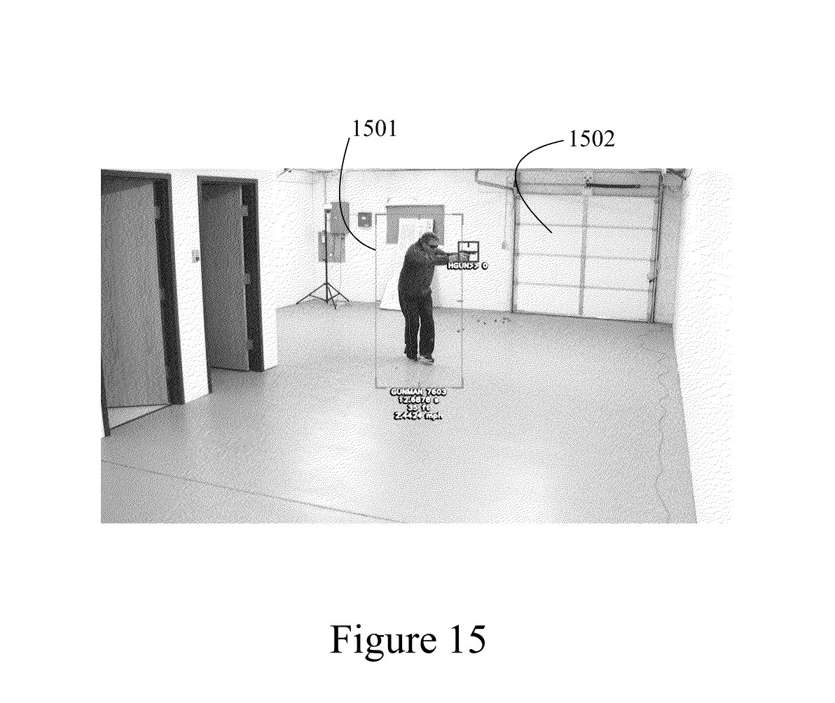

FIG. 15 is a diagram showing the complete image from the camera view, but with the framing from classification superimposed thereon. Combined image output 1501 comprises the foreground/gunman with information, superimposed onto the scene input, allowing a first responder who is familiar with the camera coverages to instantly and instinctually assess the gunman's location, probably courses of action and intentions and so on. For example, scene/background/secure classifier training facility 1502 might in fact be the entrance foyer to a public school, and the nearer of the two doorways behind the gunman might lead to a school security officer's office, which would all be extremely important tactical information. However, this is still not all that the system provides to the user.

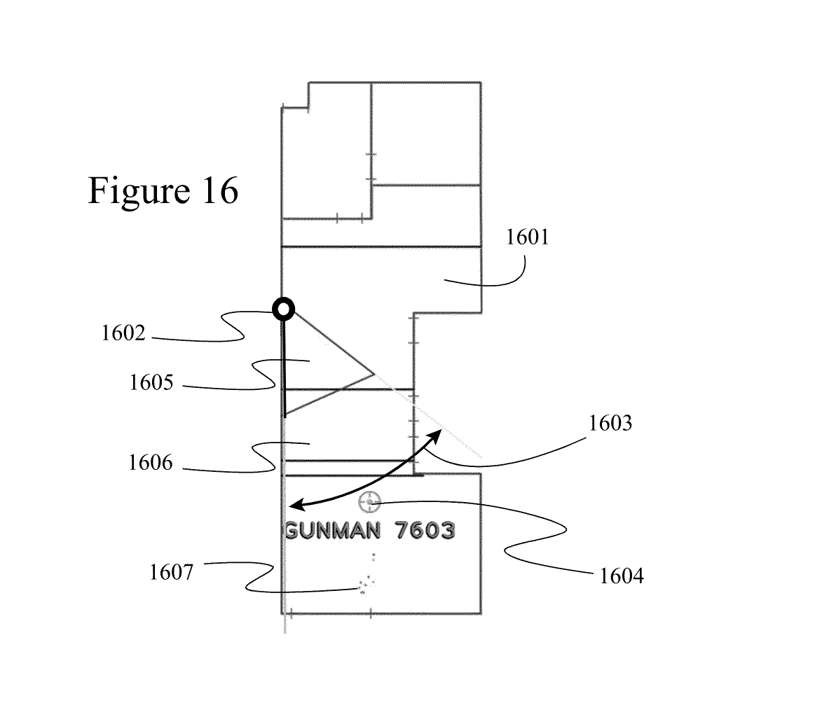

FIG. 16 is a diagram showing the mapped layout of the gunman's area. This diagram is somewhat simplified but is accurate, for example, the coverage of the tripod mounted camera visible behind the gunman in FIGS. 11 and 15 is eliminated for prosecution clarity, however, the operative system in the possession of the inventors does in fact display the coverage triangles (fields of view) of all local cameras. Note that the map of the business is in fact accurate: comparison of FIGS. 15 and 16 reveals the accurate placement of the two doorways in the background, the gunman's location, the existence of a third, proximate doorway out of view of the diagram of FIG. 15, and the existence of yet a fourth doorway at the far end of the room, leading into two smaller rooms at the upper end of the building, the secure classifier training facility 1601.

This view has been modified for clarity. In particular, the line representing the camera 1602 field of view actually is the wall at which the camera is situated. For clarity, the line is indicated quite close to the wall but detached therefrom and thus visible. In addition, the fields of view of the other cameras have been edited out of the map.

Camera 1602 is the camera which in fact produced the image of FIG. 15. The arrow 1603 is an arc indicating the field of view of camera 1602. Gunman 1604 may be seen to be inside that arc (and also within the arc of the camera 1103, though that is omitted for clarity).

There are two important subdivisions of the arc covered by the camera. The larger and more distance area 1606 is the area distant from the camera 1602 in which the gunman's feet are visible. On the other hand Area 1605 is too close to camera to allow a camera view of the floor. This is very important as it is the person bounding box/frame which allows for accurate placement of the feet in this embodiment, or the classification of the feet in other embodiments. Thus if a camera is too close (as camera 1103 might be) the ability to locate the gunman with extreme accuracy is degraded and use of a slightly more distant camera view is warranted. Note that of course one filter of the invention is one which requires an object be close enough to a camera to provide enough resolution to guarantee accurate identifications. Obviously an object so far away that it occupies only a few pixels is extremely hard to classify properly.

First foot location point 1607 is shown with a color or grey scale indicating the age of the location fix. From the map view, it becomes instantly apparent that the gunman 1604 is leaving the vicinity of the large vehicular doors at the back of the facility and approaching the (unseen) door to the smaller rooms near the front.

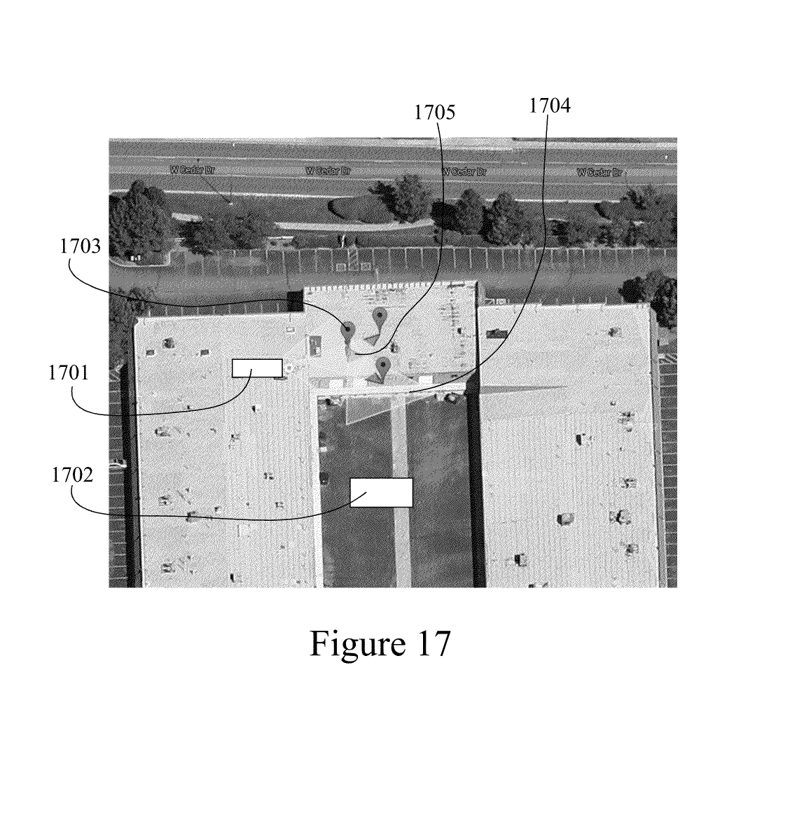

The abilities of the system are not yet exhausted. FIG. 17 is a mapped view of the gunman's location, in this case the coverage maps of the cameras are shown, as well as the overall environs and the location of the gunman. It can now be seen that the private and secure testing facility is in fact one unit in an attached industrial complex 1701, a building/structure/area display which is output to the user, and in embodiments to a generally accessible display such as a webpage.

Details of the building can be seen even in commercially available mapping software such as is available on the Internet. Exemplary building feature (rear parking lot) 1703 may be clearly seen, offering information about the gunman's possible approach route and a possible route for second responders to use to simultaneously confront the gunman from opposite directions. Camera location spot (geospatial coordinates) 1704 is even provided, along with a depiction of the field of view of the camera. Note that the other test facility cameras are included in this view, along with their fields of view, even including 1705, the area too close to the camera to allow a view of the floor.

The system of course seamlessly follows an identified threat from camera to camera, and since server operations may be centralized, even from one establishment's system to another establishment's system. For example, if the system is in use at a public school and at an adjacent bank, a gunman who first manifests himself at the bank may be followed from camera to camera within the bank, then even tracked leaving the bank and attempting to escape through the school.

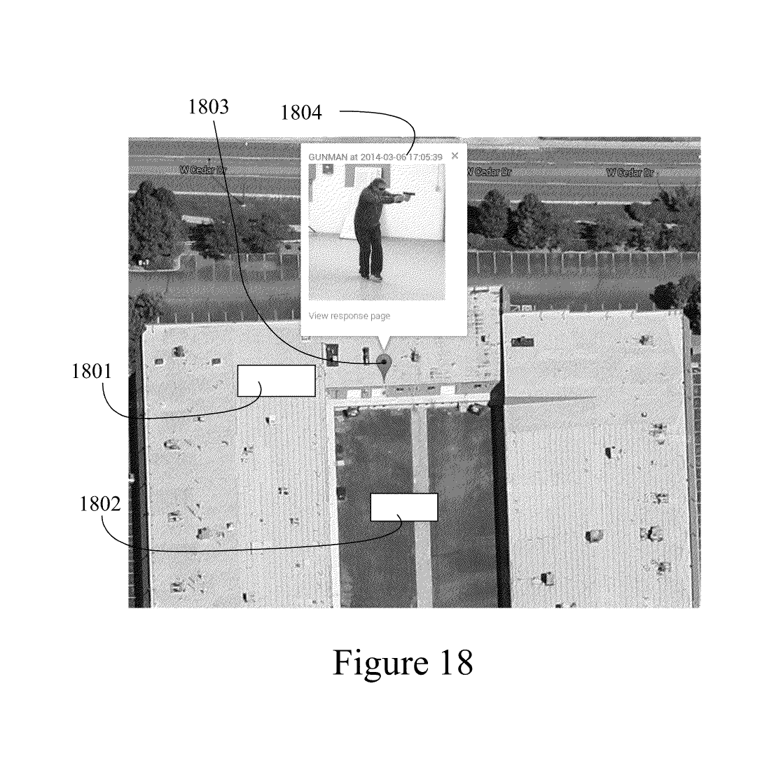

FIG. 18 is another mapped view, in this case the cameras' fields of view are omitted and instead an image based upon the image of FIG. 15 is shown instead. Building/structure/area display 1801 are output to the user, still showing exemplary building feature (rear parking lot) 1802, but now the user can see the gunman location spot 1803 (which can include geospatial coordinates if that is found helpful, since the system is actually using geospatial coordinates for the camera locations, field of view pre-calibration spots (4 per camera field), locating establishments and more).

In this view what is shown is an image 1804 of the gunman, with information: date, time, location, speed, weapon class, etc

Obviously at this point or well before this point the system will have sent the alert signal to a human monitor, the “first responder” as used herein, who will, as discussed previously, examine the images, including the image of the area, the potential gunman, the frame of the gunman, the weapon identified, the gunman's location, activity and motions, and also the reaction of human beings around the gunman. The human being is then presented with the option of escalating the alert level to a second level response or deprecating it. Note that in the event of deprecation, the system will still nonetheless track the gunman as he moves from camera FOV to camera FOV and from area to area, simply because it needs to avoid providing repetitive hits on the same individual.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims to be filed herewith.

What is claimed is:

1. A surveillance method comprising the steps of:
providing a first video surveillance camera;
providing a scene analysis component which receives a video stream from the surveillance camera;
providing a movement determination module of the scene analysis component, the movement determination module operative to separate in the video stream foreground features which are dynamic from background features which are static;
providing a contour determination module of the scene analysis component, the contour determination module operative to determine the contours of foreground features in the video stream;
providing a trained person classifier module of the scene analysis component, the trained person classifier module trained to recognize a person in the foreground video stream;
providing a trained gun classifier module of the scene analysis component, the trained gun classifier trained to recognize firearms in the foreground video stream;
operating the video surveillance camera to provide the video stream to the scene analysis trained classifier, which monitors the video stream on a continuous real-time basis, the movement determination module providing to the contour determination module foreground features, the contour determination module providing to the trained person classifier and to the trained gun classifier modules contours of foreground objects; the trained person identifier providing identification of detected persons, the trained gun classifier providing identification of detected firearms associated with detected persons;
the scene analysis component providing positive recognition of a gunman/firearm in response to identification of detected firearms associated with detected persons;
the trained classifier, upon obtaining a positive recognition of a gunman/firearm, initiating a response.

2. The surveillance method of claim 1, wherein the trained gun classifier further comprises:
at least four trained gun type/view classifiers, a handgun right-side view trained classifier, a handgun left-side view trained classifier, a long-gun right-side view trained classifier, a long-gun left-side view trained classifier.

3. The surveillance method of claim 2, wherein the trained person classifier further establishes a person bounding box about any identified person, and further establishing left and right extension boxes as left and right regions of interest in relation to the person bounding box, the trained gun classifier using the left and right regions of interest as boundaries for its detection of firearms, the extension boxes in relation to person bounding box having one of the characteristics selected from the group consisting of: partially overlapping the person bounding box, partially overlapping one another, entirely overlapping the person bounding box, extending beyond the person bounding box and combinations thereof.

4. The surveillance method of claim 3, wherein a foot position is established at the centerline of the person bounding box and located ⅙ of the box height from the bottom of the box, the foot position updated continuously.

5. The surveillance method of claim 4, wherein at least one of the trained classifiers further comprises: a cascade classifier having a plurality of stages, each stage having unique vectors for filtering the video stream, each stage filtering the video stream in sequence.

6. The surveillance method of claim 5, further comprising the step of:
establishing a gun bounding box about the detected firearms.

7. The surveillance method of claim 6, further comprising: a trained crowd classifier operative to identify crowds of persons.

8. The surveillance method of claim 1, further comprising:
training the trained classifiers of the system using a firearms database, the firearms database having therein numerous and differing images of firearms.

9. The surveillance method of claim 1, further comprising:
providing a secure training facility;
providing a simulated gunman who passes across a field of view of the first camera;
training the trained classifiers of the system using the video stream produced in the secure training facility.

10. The surveillance method of claim 1, further comprising: maintaining a set of vectors within the trained classifiers as a secret, so as to prevent gunmen from determining methods of evading detection.

11. The surveillance method of claim 1, further comprising:
an initial training stage in which persons/guns are manually indicated by bounding boxes in order to bootstrap the first iteration of the trained classifiers;
a secondary training stage in which persons/guns identified by the trained classifiers of the system are manually corrected.

12. The surveillance method of claim 1, further comprising:
providing a threat management component, the threat management component operative to receive the initiation of a response from the scene analysis component and begin procedures including at least one method selected from the group consisting of: tracking of the positive recognized firearm, initiation and maintenance of multichannel communications, maintenance of a response status indicator, execution of responsive measures and combinations thereof.

13. The surveillance method of claim 1, further comprising:
providing at least a second video surveillance camera providing at least a second video stream to the scene analysis component, the first and second cameras forming a first network.

14. The surveillance method of claim 13, further comprising:
providing a second network comprising third and fourth video surveillance cameras providing at least a third and fourth video streams to the scene analysis component, the scene analysis component being located remotely, digitally programmed in a non-volatile memory of a computer processing unit;
tracking the gunman/firearm whenever the gunman/firearm is in the field of view of any camera in either the first or second network.

15. The surveillance method of claim 4, further comprising the steps of:
pre-calibrating a plurality of locations within the field of view of the first camera using geospatial coordinates;
performing a perspective transformation between locations within the camera video stream and the pre-calibrated geospatial coordinate positions within the camera field of view;
mapping the calculated foot position using geospatial coordinates;
providing a foot location history showing past foot positions;
mapping the foot location and foot location history onto a map using the geospatial coordinates;
displaying the map having the foot location.

16. The surveillance method of claim 15, further comprising the steps of:
displaying the video stream having the gunman/firearm therein, superimposed with the person bounding box, the firearm bounding box, an identifier unique to the gunman, annotations of gunman geospatial coordinates location, time, rate of motion of the foot position.

17. The surveillance method of claim 16, further comprising the steps of:
displaying an alert offering a choice selected from the group consisting of: respond, do not respond, tag as false positive, tag as foe (armed, threat, continue to track), tag as friend (armed, threat, continue to track), and combinations thereof.

18. The surveillance method of claim 17, wherein the step of displaying an alert further comprises:
displaying an alert on a security monitor, displaying an alert on an SMS message,
displaying an alert in an email, displaying an alert on a website, and combinations thereof.

19. The surveillance method of claim 15, further comprising:
displaying by means of a network the video stream having the gunman/firearm thereon.

20. The surveillance method of claim 19, further comprising:
updating the display until the gunman/firearm are no longer visible to any camera.

21. A trained classifier of gunmen, the trained classifier produced by the following steps:
providing a secure training facility;
providing a simulated gunman who passes across a field of view of the first camera;
training a cascading classifier having multiple stages, using the video stream produced in the secure training facility, whereby a set of vectors for each stage is produced;
maintaining a set of vectors within the trained classifier as a secret.
